(19) United States
(12) Patent Application Publication
(10) Pub. No.: US 2015/0095148 A1
(43) Pub. Date: Apr. 2, 2015

(54) ENGAGEMENT MODE MARKETPLACE WITH ENHANCED BIDDING

(71) Applicant: Vantage Media LLC, El Segundo, CA (US)

(72) Inventors: Patrick Quigley, El Segundo, CA (US); Quang Nguyen, Palm Springs, CA (US); Todd Faucher, Palm Springs, CA (US)

(21) Appl. No.: 14/485,565

(22) Filed: Sep. 12, 2014

Related U.S. Application Data
(60) Provisional application No. 61/885,472, filed on Oct. 1, 2013.

(51) Int. Cl. G06Q 30/02

(52) U.S. Cl. CPC G06Q 30/0275; G06Q 30/0257; G06Q 30/0255; G06Q 30/0269
USPC 705/14.53; 705/14.55

(57) ABSTRACT

A system and method for generating a marketplace on a computing system that allows advertisers to bid for different modes of engagement with consumers that show an interest in the goods or services offered by the advertisers. The system allows advertisers to bid for opportunities to engage with consumers via one or more publishers, the opportunities offering different modes of engagement with consumers. The modes of consumer engagement include, but are not limited to, a click or other expression of interest that leads to a referral of the consumer to an advertiser website, a call or other communication that leads to a voice connection between the consumer and the advertiser, a submission of one or more pieces of information about the consumer including a request for the advertiser to contact the consumer and/or provide content about the advertiser, and an opportunity to enter into a chat session with an advertiser.

### CROSS-REFERENCE TO RELATED APPLICATIONS

This application claims priority to and the benefit of U.S. Provisional Application No. 61/885,472, entitled ENGAGEMENT MODE MARKETPLACE WITH ENHANCED BIDDING, filed on Oct. 1, 2013, which is hereby incorporated by reference in its entirety.

### BACKGROUND

In today's digital world, advertisers compete to reach the vast number of consumers that perform research online before purchasing goods or services. To attract consumers, advertisers place advertisements on various websites, whether the websites of traditional print media (e.g., the New York Times™), specialized media (e.g., TechCrunch™), search engines (e.g., Google™), or any other individual, corporate, or government site from which information might be sought. To help promote and direct online consumer traffic, various marketplaces have emerged that allow advertisers to bid for the opportunity to connect with those consumers. For example, Google's AdWords™ program allows advertisers to bid for keywords and have advertisements displayed to a consumer when the consumer uses the purchased keyword in a search string. Typically, such marketplaces have employed an auction process to allow competing advertisers to bid for the traffic of interested consumers. For example, each advertiser indicates the price they are willing to pay for the engagement of a group of consumers, who may be associated with a keyword, a geographic region, and so on, and a consumer who falls in that group will be directed to the advertiser offering the highest price. Unfortunately, existing marketplaces have proven to be inefficient for advertisers. The cost of advertising can often be expensive, and the quality of the referred consumers poor. As a result, advertisers have continued to search for ways in which they can more efficiently spend their online marketing budget.

### BRIEF DESCRIPTION OF THE DRAWINGS

FIG. 1 is a diagram illustrating an example environment in which a system operates that allows advertisers to bid in a marketplace for opportunities to engage with potential customers via different modes of engagement on a publisher website.

FIG. 2A is an example graphical user interface (GUI) of a publisher that allows a consumer to view a list of advertisers of interest and select a mode that the consumer would like to engage with the selected advertiser.

FIG. 2B is a flowchart of a process implemented by a publisher and/or by the marketplace system to enable consumers to select an engagement mode.

FIG. 3 is an example GUI generated by the marketplace system that allows an advertiser to construct bids for a campaign within a market segment.

FIG. 4 is another example GUI generated by the marketplace system that allows an advertiser to manage budgets for an advertising campaign.

FIG. 5 is a flowchart illustrating an example process in which the marketplace system enables an advertiser to construct bids for opportunities to engage with consumers.

FIG. 6 is a flowchart of an example process implemented by the marketplace system where the system calculates enhanced bid amounts and determines the advertisers that are presented to a consumer.

FIG. 7 is a representative table that stores a performance index associated with each source of engagement opportunities that is auctioned through the marketplace.

FIG. 8 is an example GUI generated by the marketplace system to allow an advertiser to review campaign results.

### DETAILED DESCRIPTION

A system and method is disclosed herein for creating a marketplace on a computing system that allows advertisers to bid for different modes of engagement with consumers that show an interest in the goods or services offered by the advertisers. The modes of consumer engagement include, but are not limited to, a click or other expression of interest that leads to a referral of the consumer to an advertiser website, a call or other communication that leads to a voice connection between the consumer and the advertiser, a submission of one or more pieces of information about the consumer including a request for the advertiser to contact the consumer and/or provide content about the advertiser, and an opportunity to enter into a chat session with an advertiser. If the consumer engages with the advertiser via one of the engagement modes, the advertiser is charged the bid amount associated with that mode subject to certain modifications of the bid amount as described in additional detail herein.

Various embodiments of the invention will now be described. The following description provides specific details for a thorough understanding and an enabling description of these embodiments. One skilled in the art will understand, however, that the invention may be practiced without many of these details. Additionally, some well-known structures or functions may not be shown or described in detail, so as to avoid unnecessarily obscuring the relevant description of the various embodiments. The terminology used in the description presented below is intended to be interpreted in its broadest reasonable manner, even though it is being used in conjunction with a detailed description of certain specific embodiments of the invention.

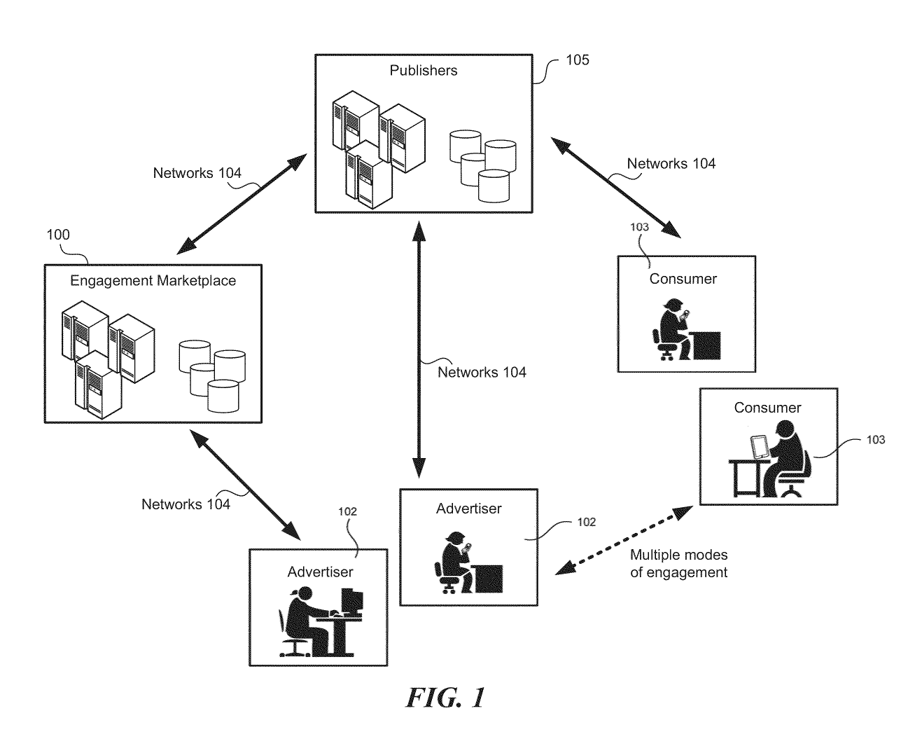

FIG. 1 is a diagram illustrating a representative environment in which the marketplace system 100 operates. The system 100 allows advertisers 102 to reach consumers 103 by bidding in a marketplace for opportunities to engage with consumers via one or more publishers, the opportunities offering different modes of engagement with consumers. The modes of consumer engagement include, but are not limited to, a click or other expression of interest that leads to a referral of the consumer to a website of the advertiser (such an engagement mode generically referred to hereinafter as a “click”), a call or other communication that leads to a voice connection between the consumer and the advertiser (hereinafter referred to as a “call”), a submission of one or more pieces of information about the consumer including a request for the advertiser to contact the consumer and/or provide content about the advertiser, such as text or video content (hereinafter referred to as a “inquiry”), and an opportunity to enter into a chat session with an advertiser (hereinafter referred to as a “chat”). Allowing consumers to select a mode of engagement with advertisers has been found to increase the responsiveness of consumers, since each consumer is allowed to select a mode of engagement with which they are the most comfortable. Moreover, advertisers are allowed to limit their advertising efforts to specific modes of customer engagement or customers who have desirable attributes, thereby providing greater flexibility with their online marketing budget and more control over the quality of the audience of their advertisements.

The engagement marketplace is hosted by a system 100 comprised of one or more servers and one or more storage devices. The advertisers can use a variety of client devices 102, such as mobile devices (e.g., phones, tablets, laptops), desktop computers, and servers to access the engagement marketplace. Each of the publishers operates through a system 105 comprised of one or more servers and one or more storage devices. Consumers use a variety of client devices 103 to access the publishers' websites and engage with advertisers, such as using mobile devices (e.g., phones, tablets, laptops) and desktop computers.

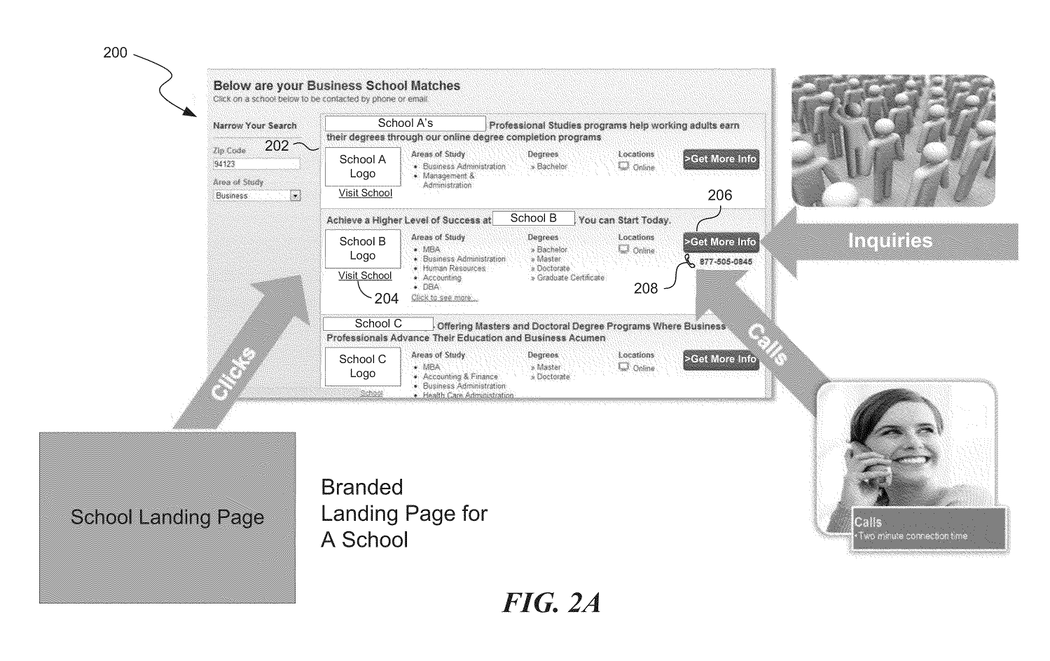

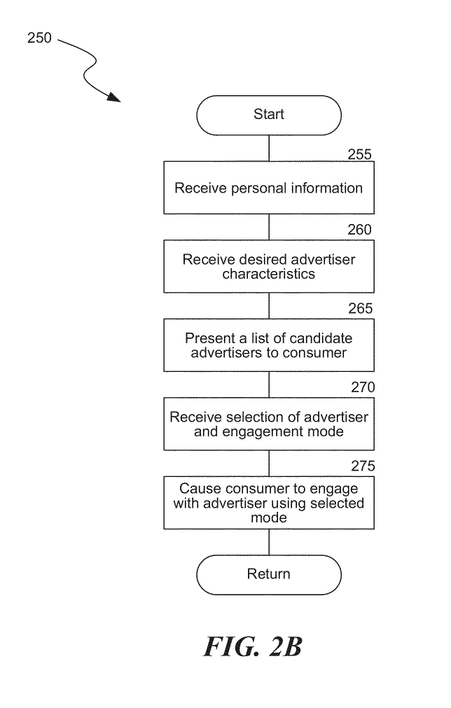

FIG. 2A is an example graphical user interface 200 (GUI) such as might be generated by a publisher. The interface allows a consumer to view a list of advertisers of interest and select an engagement mode (in the depicted case a click, call, or inquiry) that the consumer would like to use to engage with the desired advertiser. When a consumer selects one of the modes of engagement with an advertiser, they are connected to the advertiser via the selected mode. As will be described in additional detail herein, the advertiser will be charged depending on the consumer's selected mode of engagement.

FIG. 2B is a flowchart illustrating an example process 250 by which a publisher, operating in conjunction with the marketplace system 100, presents a list of advertisers to a consumer and allows the consumer to engage with a desired advertiser in a selected engagement mode. At a block 255, the publisher or the marketplace system may provide a series of questions to the consumer to collect information from the consumer. The collected information may include personal information characterizing the consumer (e.g., contact information, age, geographic location, occupation, education level, income level, health status, graduation year, military service, prior employment history, credit score or credit worthiness, driving history, characteristics of owned houses and cars, names and characteristics of family members, favored activities, spending habits, etc.) as well as information about intended actions that the consumer may be interested in undertaking (e.g., receive an insurance quote, obtain a loan, obtain information about colleges, receive information about products or services, etc.). While various examples have been provided about the type of information that may be collected about a consumer, it will be appreciated that any type of characterizing information that consumers are willing to provide to a publisher or the marketplace system may be collected.

At block 260, the publisher or the marketplace system may allow the consumer to specify desired advertiser characteristics based on the intended action. For example, if a prospective student is looking for specific education programs, he or she may specify the desired location of a school, degree programs offered by the school, tuition requirements of the school, etc. As another example, if the consumer is looking for a loan, the consumer may specify whether it is a home loan, an automobile loan, a vacation home loan, etc. With the data provided by the consumer, the engagement marketplace system 100 selects a set of advertisers to present to the consumer, using the process discussed in greater detail below. The set of advertisers is provided to the publisher or served by the system 100 on behalf of the publisher. At a block 265, the publisher presents the selected advertisers which have the desired qualifications to the consumer. Each advertiser is presented in conjunction with one or more controls (e.g., button, dial, link, etc.) that the consumer can use to select the engagement mode with the advertiser. If one of the advertisers appears compelling to the consumer, the consumer can elect to engage with that advertiser. At a block 270, the publisher receives an indication from the consumer of (1) a desired advertiser to engage with; and (2) the mode of engagement that is preferred by the consumer. In general, the consumer is allowed to reach out to any of the advertisers on the list via any of the displayed engagement modes. At a block 275, the publisher or marketplace system cause the consumer to be engaged with the selected advertiser using the desired mode of engagement. The engagement may be facilitated by a hyperlink, VoIP link, email request, form submission, or any other technique that allows the advertiser to connect with the consumer.

The marketplace system 100 allows an advertiser to place a base bid for engagement opportunities associated with each of the different modes of engagement with a consumer (e.g., click, call, chat, inquiry, or the like) within a particular vertical market segment (e.g., post-secondary education, personal loans, auto insurance, health insurance, home repair, TV, phone and other digital services, etc.). The base bid sets a rough value that the advertiser attributes to that particular type of opportunity to engage with a consumer. For example, an advertiser may assign a value of $10 to a click, $50 for a call, and $15 for an inquiry from a potential consumer. Advertisers are typically willing to pay more for one type of engagement over another if they believe that they are more likely to convert that type of engagement over other types of engagements. For example, advertisers with strong call centers may prefer to pay more for a call from a consumer, whereas advertisers with poor or no call centers may prefer to pay more for click or inquiry engagements. By allowing an advertiser to set different base bids for each mode of engagement, the marketplace system allows advertisers to (1) engage all consumers based on the consumers' engagement preference; and (2) optimize the mix of engagements based on how the advertisers would like to engage consumers, usually driven by the internal operations of the advertisers.

In addition to setting a base bid, the marketplace system 100 allows an advertiser to modify each base bid with one or more enhanced bids. An enhanced bid is an amount by which the advertiser is willing to increase or decrease their base bid if a consumer satisfies one or more selected attributes. For example, an advertiser may indicate that they are willing to pay up to 20% more than a base bid for engagement opportunities associated with consumers in a certain geography and 15% less than a base bid for engagement opportunities associated with consumers in a different geography. As another example, advertisers may be willing to pay up to 50% more than a base bid for engagement opportunities associated with consumers that self-identify has having a college degree.

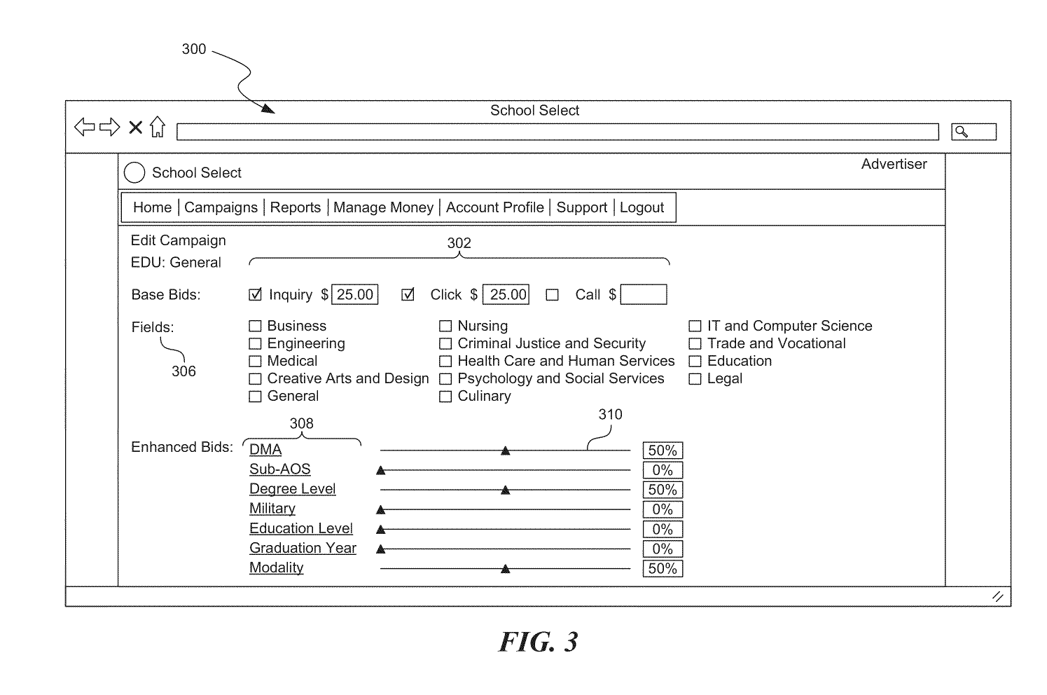

FIG. 3 is an example graphical interface 300 generated by the marketplace system 100 that allows an advertiser to construct bids for a campaign within a vertical market segment. The advertiser sets base bids 302 by specifying a dollar amount for the selected mode of engagement. The advertiser optionally sets one or more enhanced bids 308 using sliders 310 to specify percentage increases or decreases to the base bid. It will be appreciated that rather than use sliders, the interface may be configured to allow the advertiser to set enhanced bids using rotary dials, using direct keyed entry of bid amounts, using radio buttons, or via other controls known to one skilled in the art. While the enhanced bids in FIG. 3 are depicted as ranging between 0-100%, it will be appreciated that the enhanced bids may be negative (e.g., −25%) for less desirable characteristics and may be specified using a measure other than a percentage. Moreover, the range of enhanced bids is not limited to 0-100%, and can extend to multiples of a base bid, for example, 300% or 900%. In addition, the advertiser may select one or more additional fields 306 that will be used to specify characteristics of the desired engagement opportunities. By allowing an advertiser to set different bids for each engagement mode that they bid on, as well was set enhanced bids for each consumer attribute that the advertiser favors or disfavors, the disclosed marketplace allows advertisers to quickly and easily set bid parameters that are commensurate with the desired goals of an advertising campaign. Moreover, the disclosed marketplace allows advertisers to easily spread their advertising campaigns across multiple modes of consumer engagement using a single interface.

In some embodiments, the system 100 may also allow the advertiser to specify characteristics of certain consumers that the advertiser would not like to engage with. In other words, the advertiser can set barring characteristics that, when present in the consumer, mean that the consumer will not be provided with the opportunity to engage with the advertiser. By allowing the advertiser to set barring characteristics, the advertiser is able to filter out interactions with certain consumers that don't meet the desired characteristics of the advertiser.

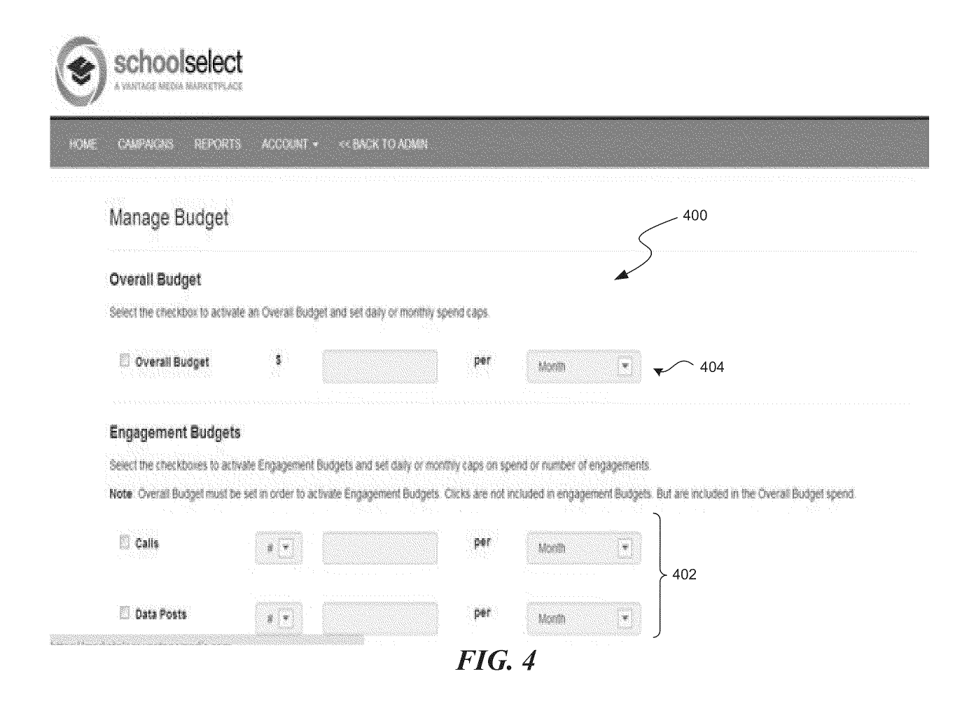

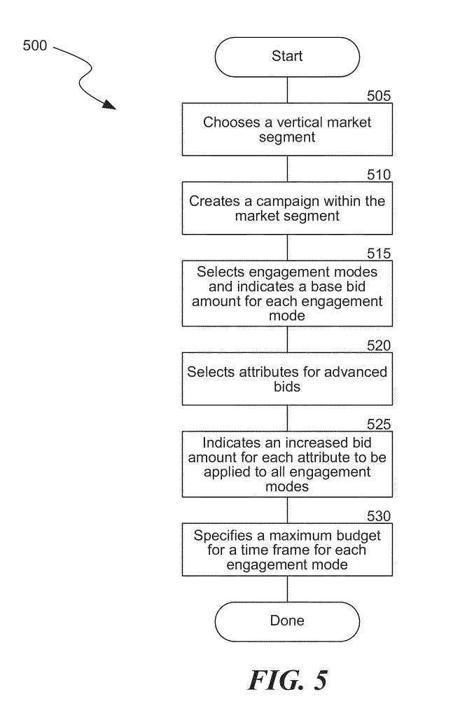

To allow an advertiser to control the maximum amount that they will pay over time for consumer engagements, the marketplace system 100 allows an advertiser to set maximum spend thresholds on a daily, weekly, monthly, or any other timeframe basis. For example, an advertiser may cap their aggregate successful bid amounts at $1,000 a day, $10,000 a month, or the like. FIG. 4 is an example of a graphical interface 400 generated by the marketplace system 100 that allows an advertiser to set limits on an advertising campaign. Namely, the advertiser is able to define a scope of the campaign, specify monthly caps on each mode of engagement 402, and set an aggregate limit 404 for the month that can be spent on the campaign. FIG. 5 is a flowchart illustrating an example process by which the marketplace system 100 enables an advertiser to construct bids for consumer engagement opportunities.

Although the interface in FIG. 4 shows the capping period as being a monthly basis, it will be appreciated that the capped period may be any other period of time (e.g., daily, weekly, etc.). Although not shown in interface 400, the marketplace system 100 may also allow the advertiser to specify certain periods of time, such as dayparts, day of the week, month, etc., during which time a particular bid is to be active and a period of time during which the particular bid is to be inactive. During times that a bid is inactive, the marketplace system 100 does not take the bid into account when identifying potential bidders for a particular engagement opportunity.

Once an advertiser has submitted a base bid and one or more enhanced bids associated with the base bid to the marketplace system 100, the advertiser's bid is applied against other advertisers for consumer engagement opportunities sold across the marketplace. As will be described in additional detail herein, an engagement opportunity associated with a consumer—including any combination of click, call, chat, inquiry, or the like—is sold within the marketplace to a bidding advertiser. To determine which advertiser successfully purchases an engagement opportunity, the system takes into account several factors. One of the factors is the bid amount, meaning the advertiser's base bid as modified by any applicable enhanced bids. As will be discussed in additional detail herein, other factors taken into account when selecting the prevailing advertiser or advertisers in the marketplace may include such factors as relevance of the advertisement, aggregate discount, and click-through rate to arrive at an effective cost per impression (eCPM). In this fashion, the marketplace operates as an efficient mechanism to steer desirable opportunities to engage with consumers to an advertiser at a price that the advertiser is willing to pay.

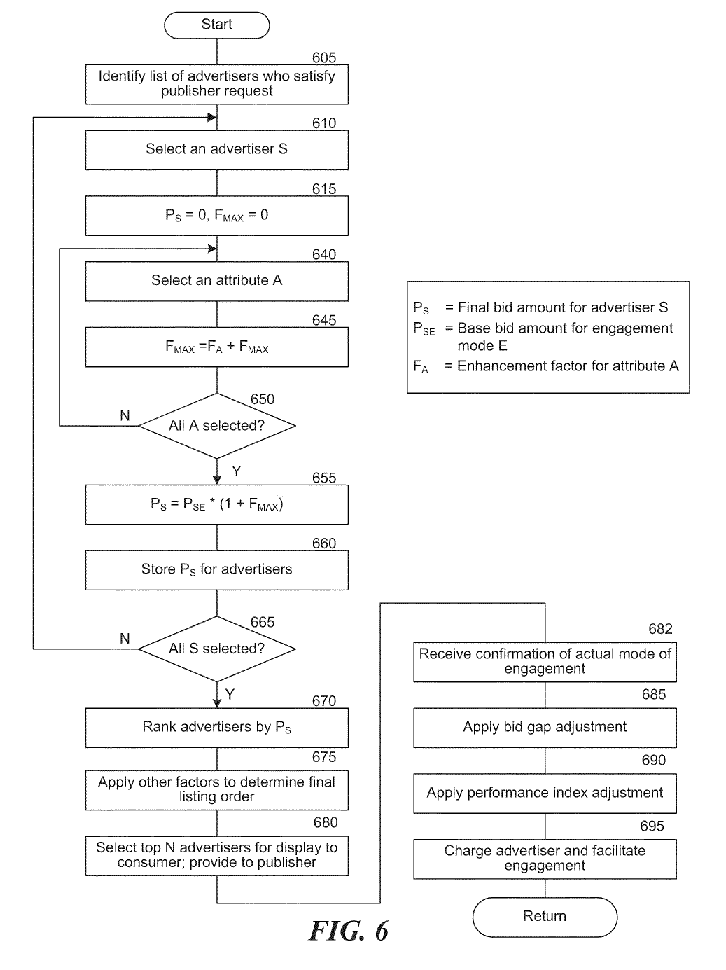

Opportunities to engage with consumers are provided by publishers to the marketplace system, which auctions the opportunities to potential advertisers. FIG. 6 is a flowchart of an example process 600 implemented by the marketplace system 100 where the system calculates the final bid amount (base bid plus any enhanced bids) for each advertiser and applies a number of other factors to determine the display order for advertisers. In addition, the system may adjust the bid amount by a bid gap adjustment and a performance index adjustment to arrive at a final price that the advertiser is to be charged for the engagement opportunity.

Processing starts at a block 605, where, for a particular engagement opportunity, the system identifies an initial list of advertisers that are seeking consumers having certain attributes associated with the opportunity. In this context, an engagement opportunity encompasses an opportunity to engage with either a single consumer or multiple consumers that share certain characteristics. The advertisers are selected for the engagement opportunity based on the vertical market segment they are targeting and any characteristics of the targeted consumers that they have specified. At block 610, the system starts considering each of the advertisers on the initial list, and at block 615 the variables used to track the final bid for the selected advertiser and the maximum enhanced bid are both reset to zero. At blocks 640-650, the system sums all applicable enhanced bids to determine the overall enhanced bid that is applicable to the engagement opportunity being bid upon. That is, the system identifies all of the enhanced bids that are associated with the specific consumer (or group of like consumers) and sums the bids for purposes of scaling the base bid. As an example, if an advertiser has specified an enhanced bid of 10% for geography (e.g., Atlanta), 25% for level of education (e.g., some college), and 20% for campus preference (e.g., urban, suburban), and all of those enhanced bids are met by the consumer engagement opportunity being bid upon, the system will set F_{MAX} at 55%.

In some embodiments, F_{MAX} may be calculated using an alternative methodology. Rather than summing all applicable enhanced bids to determine the overall scaling factor applied to the base bid for the engagement opportunity being bid upon, the system may multiply the various enhanced bid amounts together to arrive at F_{MAX}. Specifically, the system may apply the following equation (1) to calculate F_{MAX}:

F_{MAX}=[(1+F_{A1})*(1+F_{A2})*. . . (1+F_{AN})]−1 (1)

Where F_{A1,} F_{A2}, . . . F_{AN} are the various enhancement factors for each attribute. Using the same values as the previous example, F_{MAX}=[(1+0.10)*(1+0.25)*(1+0.20)]−1=65%. Such an alternative methodology works whether the factors are positive or negative, with negative factors resulting in multiplication by values less than one.

At block 655, the system increases the base bid amount by scaling the base bid amount for the advertiser by the applicable enhanced bids. That is, the system multiplies the base bid times a factor calculated using F_{MAX}. If the engagement opportunity is limited to a single mode of engagement, the base bid for that single mode of engagement is scaled by the enhanced bid. If, however, the engagement opportunity has multiple potential modes of engagement, the system may scale each of the applicable base bids or may take an average across each of the base bids and then scale the average of the base bid. At block 660, the system stores the final bid amount(s) for the advertiser, as adjusted by the enhanced bids. At block 665, the system repeats the process until it has considered all the advertisers on the initial list. At block 670, the system ranks each of the advertisers by final bid amount(s).

At block 675, the system 100 may take into account other factors to determine the final ranking of advertisers. Those factors include the relevance of the particular advertisement (e.g., if a consumer expressed interest in a degree in business management, an advertiser with a dedicated program in business management program may rank higher than an advertiser that only offers a general business program), an aggregate discount of the advertiser, and a historical click-through rate associated with the advertiser's advertisements. The aggregate discount of the advertiser is typically negotiated by the system operator with the advertiser, and may increase over time (e.g., as certain revenue volume thresholds are met) or decrease over time (e.g., when an advertiser fails to make payments to the system operator in a timely fashion). The historical click-through rate associated with advertiser's advertisements or offerings may be tracked by the system over time. Each of the factors may be weighted to arrive at an effective cost per impression (eCPM) of the advertiser for the adjusted bid combination.

Based on the final bid amount(s) and any applicable additional factors, at a block 680 the system 100 selects the top N advertisers for presentation to the consumer at the applicable publisher. N may be a single advertiser, or it may be multiple advertisers, depending on the particular requirements or obligations of the publisher. In some embodiments, the number of advertisers selected also depends on the impact of the selection on the overall eCPM of all advertisers. For example, the selection of an additional advertiser may lower the overall eCPM if the aggregate bid for the first N advertisers is higher than the aggregate bid for N+1 advertisers.

Information identifying the advertisers, providing the advertising content, and specifying the available modes of engagement with consumers on a per-advertiser basis is directly provided by the system to the publisher. Alternatively, the information identifying the advertisers may by indirectly provided, such as by providing the publisher with a link to access advertiser information that is served by another party.

The selected advertisements are presented to the consumer by the publisher, such as in the representative interface 200 depicted in FIG. 2. The interface allows the consumer to view advertisers of interest and select an engagement mode that the consumer would like to use to engage with a desired advertiser. When the consumer selects a mode of engagement, the system 100 receives confirmation of such a selection at a block 682. That confirmation may be directly received by the system (e.g., when the system serves the advertisement through the publisher), or may be received indirectly by the system (e.g., when the publisher provides an indication to the system of the selected mode of engagement).

After receiving confirmation of the actual mode of consumer engagement, the system 100 may apply various correction factors to the amount that is charged to the advertiser for that engagement. At a block 685, the system may calculate a bid gap adjustment. For example, the system may elect to charge each advertiser a fractional amount (e.g., +$0.05, +10%) over the next-highest bidder. That is, the advertiser with the highest bid pays a small amount over the second-highest bidder, the second-highest bidder pays a small amount over the third-highest bidder, etc. In this fashion, advertisers are incentivized to increase their bids since they will only be paying a nominal amount over the next-highest bidder.

After making any bid gap adjustment at block 685, processing proceeds to a block 690 where the system 100 uses a performance index to adjust the amount charged to the advertiser. As will be described in additional detail below, a performance index attempts to estimate the present value of engagement opportunities provided to the advertiser based on historical conversion information associated with prior engagement opportunities that were provided by that publisher. Once calculated, the performance index is used to adjust the final bid to arrive at the actual price to be paid by the advertiser for the corresponding engagement. The adjustment is typically downward, thereby causing the amount charged to more accurately reflect the true value of the engagement to the advertiser. The adjustment may be upward, however, if warranted by the historical conversion information. Additional details about the construction of the performance index and its use to modify a final bid amount are described below.

After application of a bid gap adjustment (if any) and a performance index adjustment, at a block 695 the system 100 charges the advertiser for the engagement. The charge may be added to the advertiser's account and the advertiser periodically billed for the outstanding balance.

It will be appreciated that various modifications could also be made to the method depicted in FIG. 6 to calculate the final bid amount. For example, rather than summing the enhanced bids and multiplying the summed amount by the base bid, the system may instead select the highest enhanced bid amount and apply it to the base bid amount. In the example above, where an advertiser has specified an enhanced bid of 10% for geography, 25% for level of education, and 20% for desired campus, the system would therefore set F_{MAX} at 25% since it is the highest enhanced bid that is applicable to the engagement.

Once engagement opportunities have been sent to an advertiser, the advertiser may provide conversion information to the marketplace system 100 as to the performance of the engagements. The conversion information may be received by the marketplace system on a periodic or continuous basis, and may be sent to the marketplace system via wired or wireless networks (e.g., the Internet) or delivered on storage media such as DVD, hard drive, flash memory, etc. In addition, the system 100 may directly derive conversion information associated with the provided advertisement. The conversion information attempts to quantify the actual value of the engagements that the advertiser received. The type and level of detail of conversion information that is received from advertisers may take a variety of forms, including, but not limited to, the following:
In some embodiments, the conversion information may be a binary (yes/no) indication of whether each consumer engagement received by the advertiser led to a desired outcome with the consumer. That outcome may be a purchase by the consumer, the receipt of certain information from the consumer (e.g., completion of a survey or response to questions), or the like.
In some embodiments, the conversion information received from the advertiser may be an actual dollar value that was attached to completing a transaction with the consumer. For example, the conversion information may reflect that a particular publisher led to a new sale at a cost of $500 per policy consumer, while another publisher led to a new sale at a cost of $1000 per policy consumer. As such, the cost of engagements with the second publisher should be discounted proportionally to the cost of engagements with the first publisher, since the second publisher costs more to drive the same result.
In some embodiments, the conversion information from an advertiser may rate the quality of the engagement with the consumer using an agreed-upon scale. For example, the transaction may be characterized by the advertiser as excellent, good, moderate, poor, or not applicable (for no transaction).
In some embodiments, multiple pieces of conversion information that reflect a consumer's progress through each stage of a transaction may be generated. For example, an advertisement for insurance may generate the following pieces of conversion information for referred engagements: (1) the initial click-through rate (as detected by the system 100 from served advertisements); (2) the conversion of a click to an inquiry on the advertiser side (as provided by the advertiser); (3) the conversion of an inquiry form to a price quote (as provided by the advertiser); and (4) the number of insurance policies actually sold from the quotes (as provided by the advertiser). Together, all four pieces of conversion information allow the marketplace system to better assess the true value of the referred engagements to the advertiser.

While various examples have been provided as to the type of conversion information directly derived by the system or provided from an advertiser, it will be appreciated that the conversion information may take various other forms and values. In some embodiments, the conversion information provided by an advertiser may vary depending on the particular market segment in which the advertiser operates. For example, advertisers that primarily sell goods may merely report an average check-out value of consumers that completed purchase transactions with the advertiser. In contrast, advertisers in the education space may report the number of consumers that completed the application process to a school, number of consumers that are accepted by the school, number of students that enroll in the school, and number of students that actually attend the school. By collecting different types of conversion information on a market-segment basis, the marketplace system is better able to assess the quality of referred engagement opportunities with respect to that market segment. Indeed, engagement opportunities from publishing sources may perform better in some market segments as opposed to other market segments, and having knowledge of where the engagement opportunities performs best allows the marketplace system to better direct the auction of engagement opportunities to one set of advertisers over another.

It will be appreciated that the conversion information from the advertiser may be received on a per-piece basis or on an aggregate basis across multiple engagement opportunities. For example, the marketplace system may receive an indication that, on average, the quality of the engagements for a particular set of 250 clicks resulted in a transaction for the advertiser valued at $5.61 per click. As another example, the marketplace system may receive an indication that the quality of engagements for bids placed on Tuesday, July 6th, was of “good” quality.

Whether received on a per-piece or on an aggregate basis, the marketplace uses its own conversion information and the conversion information from each advertiser to assess the overall quality of engagements that was referred to that advertiser and calculate a performance index for each source of engagement. The performance index will vary depending on the market vertical and the amount/type of conversion information that is received. In general, however, the performance index is a weighted average of the performance of the engagement across multiple metrics. Representative metrics include, but are not limited to, the click-through ratio (the number of times that consumers click on a presented advertiser compared to the total number of presentations of that advertiser), the inquiry conversion percentage (the number of times that consumers make an inquiry based on a presented advertiser compared to the total number of presentations of that advertiser), and the sale conversion percent (the number of times that consumers complete a sale based on a presented advertiser compared to the total number of presentations of that advertiser). To enable calculation across multiple metrics, each of the metrics may be scaled to an indexed value of between 0 and 1. Conversion to a common scale allows comparison of metrics across similarly situated website publishers or advertisers in a vertical market segment. For example, a performance index may be calculated by the following equation (2):

PI=X₁*click-through ratio+X₂*inquiry conversion percentage+X₃*sale conversion percent (2)

Where PI equals the performance index for the analyzed engagements and X_{N} are weightings applied to the different conversion metrics. In some embodiments, the performance index may be alternatively calculated using the following equation (3):

PI=X₁(1-click-through ratio)*X₂(1-inquiry conversion percentage)*X₃(1-sale conversion percent) (3)

The weightings are typically adjusted to reflect advertiser expectations in a particular vertical market segment. In some embodiments, the performance index is scaled so that it ranges between zero to one, with zero reflecting poor performance and one reflecting excellent performance. The performance index may be scaled with respect to the top converting publisher in each market segment, meaning that the top-converting publisher receives a score of one and all other publishers are scaled against that score. The performance index is calculated by the system 100 separately for each mode of engagement (e.g., click, call, chat or inquiry).

It will be appreciated that the disclosed performance indexes equations are merely representative of the type of calculations that may be used to calculate a performance index representing the quality of the quality of engagements that was referred to an advertiser. The number of metrics used to calculate the performance index, the weightings applied to each of the metrics, and the mathematical operations used to calculate the performance index may each vary. In some embodiments, for example, the performance index may be calculated against an average desired quality of engagement specified by an advertiser, rather than against a comparison of the quality of engagements across all advertisers. It will also be appreciated that a performance index may be calculated for a particular publisher website, for a particular publisher (e.g., across some or all websites operated by that publisher), or for a group of publishers.

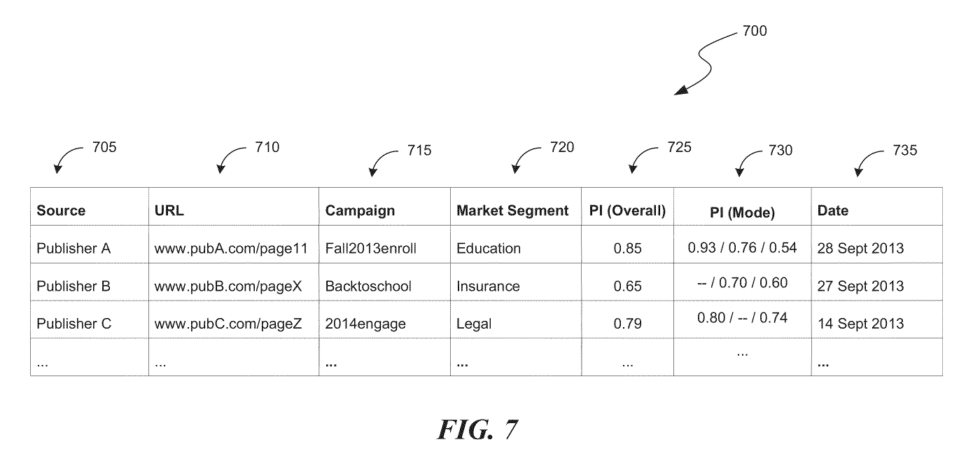

Once calculated by the system 100, a performance index is stored in association with the publisher source from which the index was derived. FIG. 7 is a representative table 700 that stores performance indices associated with each source of engagements that is auctioned through the marketplace. Each row in the table represents a particular engagement source and campaign. The publisher is identified in column 705, and may be reflected by a name, IP address, code, or other unique identifier. The URL for the location where the campaign was published is contained in column 710, and an identifier used to identify a particular advertising campaign that was used to fulfill the engagement opportunities is contained in column 715. The vertical market segment associated with the publisher is specified in column 720. The calculated performance index for the engagement source, URL, and campaign is specified in columns 725 and 730. Column 725 represents an aggregate score across all consumer engagement modes (e.g., click, call, inquiry, etc.) and column 730 represent a score for each mode of engagement. It will be appreciated that not all of the engagement modes may have an associated performance index, such as if an advertiser or publisher offers only offers a selected set of engagement modes. The aggregate score across all consumer engagement modes may be calculated using a simple or weighted average across each type of engagement mode. The table also includes a column 735 that contains the last date that the performance index data was updated. It will be appreciated that the data reflected in table 700 is merely representative of the type of data that may be stored, and that the system will typically store additional information about each publisher. For example, the system may store historical performance index information, to allow trends associated with the performance indices to be analyzed.

The marketplace system 100 uses the performance indices to adjust the amount charged to advertisers. That is, the performance index for an engagement source is used to adjust the total bid for the engagement opportunity to arrive at the actual price charged to the advertiser for the engagement. The adjustment is typically downward (although may be upward), and in some embodiments may be calculated by multiplying the performance index by the amount of the final bid. For example, assume that an advertiser's final bid was $50 a call for 100 calls. If the source for that set of calls had a performance index of 0.65, the marketplace system may charge the advertiser $32.50 for each call (0.65*$50.00). In this fashion, the advertiser actually pays less than the final bid of $50 a call. By more closely aligning the bid cost with the actual benefit received by the advertiser, the disclosed marketplace thereby offers an advertiser a compelling benefit over existing marketplaces which have fixed prices regardless of engagement quality.

When adjusting the amount charged to advertisers, the system may apply the aggregate performance index across all modes of engagement, regardless of the particular mode that is being bid upon. For example, the system may apply a performance index of 0.65 to all bids associated with clicks, calls, chats, or inquiries. Alternatively, for each mode of engagement, the system may apply the specific performance indices for that mode of engagement. For example, the system might apply a performance index of 0.58 for clicks, 0.62 for calls, 0.72 for chats, and 0.75 for inquiries. In this fashion, the advertiser receives the benefit of a discount based on actual performance for each mode of engagement.

In some circumstances, such as for new engagement opportunity sources, the system 100 may not have any conversion information associated with that source. To mitigate the risk of using new sources that have limited history, the system may assign a default performance index to the source until there are sufficient transactions associated with the source to accurately estimate the actual performance index. The default performance index can be an average or median of performance indices of similarly-situated engagement opportunity sources. The default performance index could also be an average or median of all performance indices associated with a particular market segment. For example, the system could assign the average performance index of all existing engagement opportunity sources associated with insurance to a new insurance engagement opportunity source. The default performance index may be maintained by the system until there is sufficient conversion information associated with the source to justify adjusting the performance index either up or down.

It will be appreciated that in some instances there may be significant time between when an engagement opportunity is referred to an advertiser and when the conversion information associated with that engagement is received by the marketplace operator. For example, the sales cycles of some advertisers may take a week or more before there is certainty in whether the consumer has made a purchase with the advertiser. As another example, the advertiser may report various pieces of conversion information over time (e.g., inquiry, application, enroll, attend) that each progressively give additional information about the value of the engagement to the advertiser. In cases where the conversion information is delayed, or in cases where the conversion data is incrementally received over time, the marketplace system merely uses the additional information as received to update the performance index associated with the particular source. The performance index for a source of engagement opportunities may therefore fluctuate over time, increasing if the additional conversion information indicates that the engagement had a high value to an advertiser and decreasing if the additional conversion information indicates that the engagement performed poorly for the advertiser. In some embodiments, the performance indices are calculated by the system as frequently as new conversion information is received. In some embodiments, the performance indices are calculated by the system on a periodic basis, such as daily, weekly, monthly or quarterly.

Because advertisers are charged based in part on the quality of the engagements that they receive, rather than merely on the bid that they make, the marketplace generated by system 100 is a very cost effective way for advertisers to manage advertising campaigns. To participate in the marketplace, the operator of the marketplace system 100 may therefore also charge each advertiser a fee to access the marketplace. In some embodiments, the fee may be a per-engagement fee that is tacked onto the final bid as modified by the bid gap and performance index adjustment. In some embodiments, the fee may be a subscription fee that is charged to the advertiser on a monthly basis. The subscription fee gives the advertiser access to the marketplace and access to additional analytics and tools that may be used to manage campaigns in the marketplace.

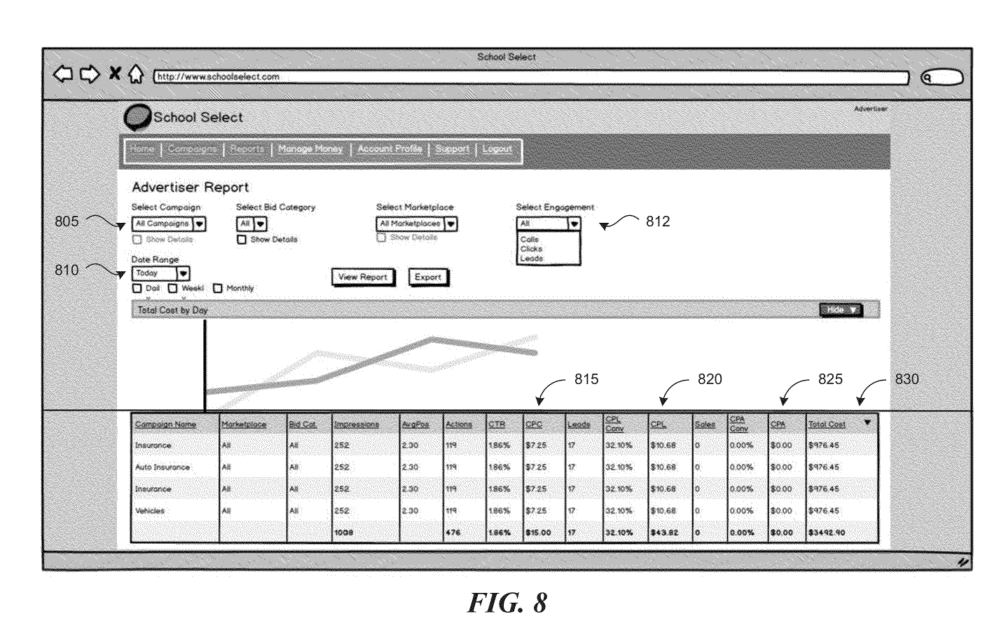

To aid an advertiser to understand the value of the engagement opportunities that they receive, the marketplace system 100 may provide one or more interfaces that allow the advertiser to view, on a market-segment basis, the results of the engagements that the advertiser receives based on the conversion information that they provide. FIG. 8 is a representative interface that is generated by the system 100 that allows an advertiser to review campaign results. In the depicted example, the advertiser can select a campaign using the dropdown list 805 and specify a time frame using the dropdown list 810. The interface also allows the advertiser to select, using dropdown list 812, the type of engagement results to view (in the depicted example, calls, clicks, or leads). The advertiser can then view various metrics associated with the operational campaigns for the selected time frame, including the number of clicks or website visits, the cost per click (CPC) 815, the number of inquiries and the corresponding cost per inquiry (lead) (CPL) 820, the number of online phone calls and the corresponding cost per action (CPA) 825, and the total cost incurred for the campaign 830, which would take into consideration the various adjustments made by the system 100 such as the bid gap adjustment and the performance index adjustment. In this fashion, the advertiser may better assess whether they are paying an amount for the engagement opportunities that is commensurate with the value that they receive.

In some embodiments, based on the bidding results, the system 100 may make one or more recommendations to the advertiser to potentially achieve better bidding results. For example, the system may alert the advertiser when the number of consumer engagements through a particular engagement mode is particularly high or low. In response to the alert, the advertiser may increase or decrease the base bid amount corresponding to the engagement mode based on the budget, the intention to further utilize the particular engagement mode, and so on. The system may also automatically redistribute the budget among the engagement modes based on the volume of engagements coming through the respective engagement modes.

In some embodiments, the system 100 may be adapted to allow an advertiser to place a base bid for engagement opportunities associated with each of the different modes of engagement with a consumer (e.g., click, call, chat, inquiry, or the like) within a particular publisher website or group of publisher websites rather than in a vertical market segment. For example, the system may allow an advertiser to indicate that they are interested in bidding for engagement opportunities only associated with the website “TechCrunch” or for engagement opportunities only associated with select web properties affiliated with Yahoo!. When implemented in such a fashion, the advertiser's bids are only applied by the system against engagement opportunities that satisfy the selected publisher or group of publishers.

Those skilled in the art will appreciate that the marketplace system 100 may be implemented on any computing system or device. Suitable computing systems or devices include personal computers, server computers, hand-held or laptop devices, multiprocessor systems, microprocessor-based systems, programmable consumer electronics, network devices, minicomputers, mainframe computers, distributed computing environments that include any of the foregoing, and the like. Such computing systems or devices may include one or more processors that execute software (in the form of program instructions) to perform the functions described herein. Processors include programmable general-purpose or special-purpose microprocessors, programmable controllers, application specific integrated circuits (ASICs), programmable logic devices (PLDs), or the like, or a combination of such devices. Software may be stored in memory, such as random access memory (RAM), read-only memory (ROM), flash memory, or the like, or a combination of such components. Software may also be stored in one or more storage devices, such as magnetic or optical based disks, flash memory devices, or any other type of non-volatile storage medium for storing data. Software may include one or more program modules which include routines, programs, objects, components, data structures, and so on that perform particular tasks or implement particular abstract data types. The functionality of the program modules may be combined or distributed across multiple computing systems or devices as desired in various embodiments.

While FIG. 7 depicts a table whose contents and organization are designed to make them more comprehensible by a human reader, those skilled in the art will appreciate that the actual data structure(s) used by the system to store this information may differ from the tables shown, in that they, for example, may be organized in a different manner, may contain more or less information than shown, may be compressed and/or encrypted, and may be optimized in a variety of ways. Those skilled in the art will further appreciate that the depicted flow charts may be altered in a variety of ways. For example, the order of the steps may be rearranged, steps may be performed in parallel, steps may be omitted, or other steps may be included.

From the foregoing, it will be appreciated that specific embodiments of the invention have been described herein for purposes of illustration, but that various modifications may be made without deviating from the scope of the invention. Accordingly, the invention is not limited except as by the appended claims.

I/We claim:

1. A method of operating a marketplace on a computing system in which advertisers bid for different engagement modes with consumers, the method comprising:
receiving indications of interest to engage with consumers from a plurality of advertisers, an indication of interest to engage with a consumer comprising:
an indication of a vertical market segment in which to advertise to the consumer;
for each of multiple modes of engagement with the consumer, an indication of a base bid amount that the advertiser will pay to interact with the consumer via the corresponding mode of engagement; and
an indication of one or more enhanced bid amounts that are to be applied to adjust an advertiser's base bid amount if the consumer satisfies a corresponding attribute;
receiving indications from a website publisher of an opportunity to engage with consumers, the opportunity to engage with consumers having multiple modes of engagement,
comparing the received indications of interest from the plurality of advertisers with the opportunity to engage with consumers received from the website publisher and identifying one or more advertisers for the website publisher based on corresponding base and enhanced bid amounts of the identified advertisers;
providing an indication of the identified advertisers to the publisher;
receiving an indication of an advertiser selected by a consumer and a selected mode of engagement made by the consumer to engage with the advertiser; and
charging the selected advertiser for the consumer engagement based on the base bid amount associated with the selected engagement mode as adjusted by any applicable enhanced bid amounts.

2. The method of claim 1, wherein the multiple modes of engagement between the consumer and the advertiser are selected from the group consisting of click, call, chat or inquiry.

3. The method of claim 1, wherein an enhanced bid amount increases or decreases a base bid amount.

4. The method of claim 1, wherein a consumer attribute is selected from the group consisting of contact information, age, geographic location, occupation, education level, income level, health status, graduation year, military service, and prior employment history.

5. The method of claim 1, wherein the indication of an advertiser selected by a consumer is received from the website publisher.

6. The method of claim 5, wherein the indication of the engagement mode selected by the consumer is also received from the website publisher.

7. The method of claim 1, wherein providing an indication of the selected advertisers to the publisher comprises serving advertisements associated with the selected advertisers to a consumer on behalf of the publisher, and receiving an indication of an advertiser selected by a consumer comprises receiving a selection of a mode of engagement with an advertiser by the consumer.

8. The method of claim 1, wherein the indication from the website publisher of the opportunity to engage with consumers further contains an indication of attributes of the consumers.

9. The method of claim 8, wherein an advertiser is identified for the website publisher based on the advertiser's base bid amounts as adjusted by enhanced bid amounts applicable to the attributes of the consumers received from the website publisher.

10. The method of claim 9, wherein an advertiser is further selected for the website publisher based on a relevance of an advertisement associated with the advertiser.

11. The method of claim 9, wherein an advertiser is further selected for the website publisher based on a historical click-through rate associated with the advertiser's advertisements.

12. The method of claim 9, wherein an advertiser is further selected for the website publisher based on an aggregate discount associated with advertiser.

13. The method of claim 1, wherein the vertical market segment is selected from the group consisting of education programs, financial loans, or insurance.

14. The method of claim 1, further comprising, when identifying one or more advertisers for the website publisher, ignoring indications of interest from advertisers that have exceeded an advertising budget within a predetermined timeframe.

15. A tangible computer-readable medium containing instructions that, when executed by a processor, cause the processor to perform a method of operating a marketplace on a computing system in which advertisers bid for different engagement modes with consumers, the method comprising:
receiving indications of interest to engage with consumers from a plurality of advertisers, an indication of interest to engage with a consumer comprising:
an indication of a vertical market segment in which to advertise to the consumer;
for each of multiple modes of engagement with the consumer, an indication of a base bid amount that the advertiser will pay to interact with the consumer via the corresponding mode of engagement; and
an indication of one or more enhanced bid amounts that are to be applied to adjust an advertiser's base bid amount if the consumer satisfies a corresponding attribute;
receiving indications from a website publisher of an opportunity to engage with consumers, the opportunity to engage with consumers having multiple modes of engagement,
comparing the received indications of interest from the plurality of advertisers with the opportunity to engage with consumers received from the website publisher and identifying one or more advertisers for the website publisher based on corresponding base and enhanced bid amounts of the identified advertisers;
providing an indication of the identfied advertisers to the publisher;
receiving an indication of an advertiser selected by a consumer and a selected mode of engagement made by the consumer to engage with the advertiser; and
charging the selected advertiser for the consumer engagement based on the base bid amount associated with the selected engagement mode as adjusted by any applicable enhanced bid amounts.

16. The tangible computer-readable medium of claim 15, wherein the multiple modes of engagement between the consumer and the advertiser are selected from the group consisting of click, call, chat or inquiry.

17. The tangible computer-readable medium of claim 15, wherein providing an indication of the identified advertisers to the publisher comprises serving advertisements associated with the identified advertisers to a consumer on behalf of the publisher.

18. The tangible computer-readable medium of claim 15, wherein the indication from the website publisher of the opportunity to engage with consumers further contains an indication of attributes of the consumers.

19. The tangible computer-readable medium of claim 18, wherein an advertiser is identified for the website publisher based on the advertiser's base bid amounts as adjusted by enhanced bid amounts applicable to the attributes of the consumers received from the website publisher.

20. The tangible computer-readable medium of claim 19, wherein an advertiser is further identified for the website publisher based on a relevance of an advertisement associated with the advertiser.

21. The tangible computer-readable medium of claim 19, wherein an advertiser is further identified for the website publisher based on a historical click-through rate associated with the advertiser's advertisements.

22. The tangible computer-readable medium of claim 19, wherein an advertiser is further identified for the website publisher based on an aggregate discount associated with advertiser.

23. A method of operating a marketplace on a computing system in which advertisers bid for different engagement modes with consumers, the method comprising:
receiving indications of interest to engage with consumers from a plurality of advertisers, an indication of interest to engage with a consumer comprising:
an indication of a vertical market segment in which to advertise to the consumer; and
for each of multiple modes of engagement with the consumer, an indication of a base bid amount that the advertiser will pay to interact with the consumer via the corresponding mode of engagement;
receiving indications from a website publisher of an opportunity to engage with consumers, the opportunity to engage with consumers having multiple modes of engagement,
comparing the received indications of interest from the plurality of advertisers with the opportunity to engage with consumers received from the website publisher and identifying one or more advertisers for the website publisher based on corresponding base amounts of the identified advertisers;
providing an indication of the identified advertisers to the publisher;
receiving an indication of an advertiser selected by a consumer and a selected mode of engagement made by the consumer to engage with the advertiser; and
charging the selected advertiser for the consumer engagement based on the base bid amount associated with the selected engagement.

24. A tangible computer-readable medium containing instructions that, when executed by a processor, cause the processor to perform a method of operating a marketplace on a computing system in which advertisers bid for different engagement modes with consumers, the method comprising:
receiving indications of interest to engage with consumers from a plurality of advertisers, an indication of interest to engage with a consumer comprising:
an indication of a vertical market segment in which to advertise to the consumer; and
for each of multiple modes of engagement with the consumer, an indication of a base bid amount that the advertiser will pay to interact with the consumer via the corresponding mode of engagement;
receiving indications from a website publisher of an opportunity to engage with consumers, the opportunity to engage with consumers having multiple modes of engagement,
comparing the received indications of interest from the plurality of advertisers with the opportunity to engage with consumers received from the website publisher and identifying one or more advertisers for the website publisher based on corresponding base amounts of the identified advertisers;
providing an indication of the identified advertisers to the publisher;
receiving an indication of an advertiser selected by a consumer and a selected mode of engagement made by the consumer to engage with the advertiser; and
charging the selected advertiser for the consumer engagement based on the base bid amount associated with the selected engagement mode.

25. A tangible computer-readable medium of claim 24, wherein the multiple modes of engagement between the consumer and the advertiser are selected from the group consisting of click, call, chat or inquiry.

26. A tangible computer-readable medium of claim 24, wherein providing an indication of the identified advertisers to the publisher comprises serving advertisements associated with the identified advertisers to a consumer on behalf of the publisher.

27. The tangible computer-readable medium of claim 24, wherein an advertiser is further identified for the website publisher basd on a relevance of an advertisement associated with the advertiser, a historical click-through rate associated with the advertiser's advertisements, or an aggregate discount associated with advertiser.
